(19) United States
(12) Patent Application Publication
(10) Pub. No.: US 2006/0075783 A1
(43) Pub. Date: Apr. 13, 2006

(54) Method for strengthening flat glass plate for display

(76) Inventors: Jae Seon Kim, Suwon-si (KR); Sergey K. Evstropiev, Suwon-si (KR)

Correspondence Address: David A. Einhorn, Esq.;Anderson Kill & Olick, P.C., 1251 Avenue of the Americas, New York, NY, 10020, US

(21) Appl. No.: 11/226,607

(22) Filed: Sep. 13, 2005

(30) Foreign Application Priority Data
Sep. 13, 2004 (KR) 10-2004-0072876

(51) Int. Cl. C03C 17/00

(52) U.S. Cl. 65/60.5

(57) ABSTRACT

A flat glass plate can be strengthened by way of forming a solid layer comprising a potassium salt and an inorganic oxide on the glass plate, followed by heat-treatment at a temperature ranging from 400° C. to the strain point of the glass.

### FIELD OF THE INVENTION

The present invention relates to a method for preparing a high strength flat glass plate which is suitable for use as a display panel.

### BACKGROUND OF THE INVENTION

A thin flat glass plate with high strength is used in the manufacture of a display such as a thin film transistor liquid crystal display (TFT-LCD), plasma display panel (PDP) and electroluminescent (EL) device. In order to enhance the strength of a plate glass, U.S. Pat. No. 6,607,999, European Publication Patent No. 1388881 A2 and Japanese Patent No. 2837134 disclose a method of chemically strengthening the glass plate surface through ion exchange of alkali metal ions at the glass plate surface.

Such a chemical strengthening method is based on an ion exchange technique to replace small sodium ions (Na⁺), present in the glass with larger alkali ions, e.g., potassium ions (K⁺) to impart compressive stress to the glass plate surface. The effectiveness of such an ion exchange process strongly depends on the ion exchange temperature. At a high ion exchange temperature, the mobility of ions becomes high, ion diffusion becomes accelerated, but also undesirable relaxation of the glass also takes place. Accordingly, the ion exchange is usually performed at a temperature higher than the melting point of the source salt, but lower than the strain point of the glass.

The above method, however, requires the step of dipping the plate glass into a salt bath containing the source salt, and thus, it is not adequate for strengthening a large-scale glass plate or for performing a local strengthening of selected parts of a glass plate.

Accordingly, U.S. Pat. No. 5,127,931 discloses a dry ion exchange method comprising coating the surface of the plate glass with a solid film containing a salt of mono or divalent cations, and then heat-treating the coated glass plate to allow ion exchange of alkali metal ions between the solid film and the glass plate. However, this method has a problem in that the solid film coated on the plate glass tends to flow at the heat-treatment temperature which is often higher than the melting point of the salt, causing unstable and uneven ion exchange at the glass plate surface.

A flat glass plate for a display is generally processed to be combined with another plate to form a sealed structure made of front and rear glass plates. The rougher the state of the glass surface region to be sealed, e.g., the periphery of the glass plate surface, the stronger the binding force of the sealed part. Thus, there have also been studied methods to roughen the specific glass surface region to be sealed.

### SUMMARY OF THE INVENTION

Accordingly, it is an object of the present invention to provide a simple method for strengthening a flat glass plate so as to impart high and uniform strength thereto.

In accordance with one aspect of the present invention, there is provided a method for strengthening a flat glass plate which comprises the steps of: forming a solid layer comprising a potassium salt and an inorganic oxide on the glass plate; heat-treating the glass plate having the solid layer at a temperature ranging from 400° C. to the strain point of the glass to allow ion exchange of alkali metal ions between the solid layer and the glass plate surface to take place; and cooling and washing the heat-treated glass plate.

### BRIEF DESCRIPTION OF THE DRAWINGS

The above and other objects and features of the present invention will become apparent from the following description of the invention, when taken in conjunction with the accompanying drawings, which respectively show:

FIG. 1: the change in the microhardness (MPa) of the glass plate ion exchange-treated with a mixture of potassium nitrate and aluminum oxide as function of the molar fraction (mol %) of potassium nitrate in the mixture, observed in Example 1; and

FIG. 2: an SEM photograph of the surface of the glass plate ion exchange-treated with a mixture of 50 mol % of potassium nitrate, 40 mol % of aluminum oxide and 10 mol % of aluminum trichloride, prepared in Example 2.

### DETAILED DESCRIPTION OF THE INVENTION

The method of the present invention is characterized by the use of a combination of a potassium salt and an inorganic oxide as a solid salt medium for ion exchange of alkali metal ions at the glass plate surface.

In accordance with the present invention, a solid layer comprising a combination of a potassium salt and an inorganic oxide may be formed on the glass plate by the conventional methods, e.g., by applying a powdered mixture of the salt and inorganic oxide by means of electrostatic force; spraying of a dispersion or suspension of a mixture thereof and drying the dispersion layer; or a screen-printing method. The thickness of the solid layer may be preferably in the range of 0.5 to 5 mm.

Suitable for use in the present invention is an inorganic oxide which does not react with a potassium salt, and stable thermally and chemically. The inorganic oxide used in the present invention plays the role of “melt-keeper”, i.e., functions to keep the solid layer containing the molten salt in a form of wet solid at the ion exchange temperature, stably holding the salt in contact with the glass surface, thereby leading to uniform and effective ion exchange at the glass surface. Representative examples of the potassium salt used in the present invention include potassium nitrate and potassium chloride, and representative examples of the inorganic oxide; aluminum oxide, zinc oxide and zircon oxide.

The inventive solid layer may comprise 30 to 90 mol %, preferably 40 to 60 mol % of a potassium salt and 10 to 70 mol %, preferably 40 to 60 mol % of an inorganic oxide.

Then, the glass plate having the solid layer is heated to a temperature ranging from 400° C. to the strain point of the glass and then maintained at that temperature for a time sufficient for adequate alkali metal ion exchange to take place between the solid layer and the glass plate surface. During such ion exchange, a relatively large quantity of sodium ions (Na⁺) of the glass is replaced with potassium ions (K⁺) of the solid layer, which results in the generation of significant compressive stress at the glass plate surface, thereby enhancing the strength of the glass plate. The term “strain point” used herein is referred to as the temperature at which the stress formed in glass is reduced to below 250 psi within 4 hours or the viscosity of the glass becomes 10^{14.5} poise (ASTM C336-71).

When the heat-treatment temperature is less than 400° C., the diffusion of alkali metal ions at the glass surface becomes insignificant, and when it is higher than the strain point of the glass, undesired stress relaxation in the glass occurs.

The glass plate thus heat-treated is cooled to room temperature and then washed with water to remove the residual solid layer.

Further, in accordance with the present invention, for the purpose of roughening the specific glass surface region to be sealed, aluminum trichloride may be further added to the solid layer composition applied thereto. In this case, the solid layer may comprise 30 to 80 mol % of the potassium salt, 10 to 60 mol % of the inorganic oxide and 10 to 40 mol % of aluminum trichloride, wherein preferred are potassium nitrate as the salt and aluminum oxide as the inorganic oxide. The combined use of a potassium salt, an inorganic oxide and aluminum trichloride simultaneously enhances the strength and roughness of the glass plate surface.

The flat glass plate strengthened by the inventive dry ion exchange method using a combination of the potassium salt and inorganic oxide exhibits high and uniform strength. As described above, the present invention provides a simple and efficient method for preparing a high strength flat glass plate suitable for use in preparing a display such as a thin film transistor liquid crystal display (TFT-LCD), plasma display panel (PDP) and electroluminescent (EL) device. In addition, in accordance with the inventive method, selective local strengthening and roughening of a specific portion of the glass plate can also be achieved.

The following Examples are given for the purpose of illustration only, and are not intended to limit the scope of the invention.

### EXAMPLE 1

A powdered mixture of potassium nitrate (KNO₃) and aluminum oxide (Al₂O₃) having the composition shown in Table 1 was placed on the surface of a silicate glass plate containing 4.8 w/w % of Na₂O, 6.2 w/w % of K₂O, 1.66 w/w % of MgO, 5.25 w/w % of CaO, 7.2 w/w % of SrO, 8.0 w/w % of BaO, 2.7 w/w % of ZrO₂, 6.7 w/w % of Al₂O₃ and 57.3 w/w % of SiO₂ as main components, to form an 1 to 2 mm-thick solid layer thereon.

The glass plate with the solid layer was placed in a furnace, heated to 480° C. over 1 hr, and then, maintained at that temperature for 1 hr. The heat-treated glass plate was cooled to 20° C. over 2 hrs and washed with distilled water to remove the residual powder layer.

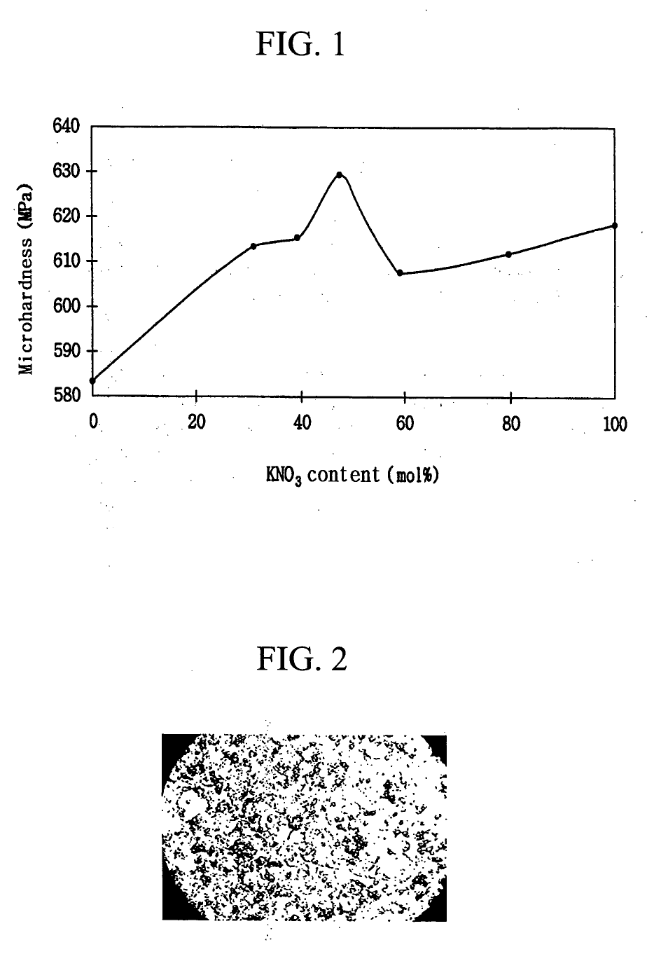

The average microhardness (MPa) of each of the glass plates ((1-1) to (1-6)) thus obtained was determined at five points using a 100 g load with a 15 Vicker's hardness gage and compared with that of the original untreated glass plate (control). The results are shown in Table 1. The change in the microhardness of the glass plate as function of the molar fraction (mol %) of potassium nitrate is shown in a graph form in FIG. 1.

TABLE 1

| | Salt-containing | | | |
|---|---|---|---|---|
| | mixture (mol %) | | Average | Standard |
| Sample | KNO₃ | Al₂O₃ | microhardness (MPa) | variation |
| Control | — | — | 583.5 | 13.8 |
| (1-1) | 100 | 0 | 611.2 | 11.9 |
| (1-2) | 80 | 20 | 610.4 | 6.7 |
| (1-3) | 60 | 40 | 605.7 | 9.0 |
| (1-4) | 50 | 50 | 633.0 | 9.8 |
| (1-5) | 40 | 60 | 617.5 | 8.6 |
| (1-6) | 30 | 70 | 613.9 | 7.6 |

As shown in Table 1, the glass plates ((1-2) to (1-6)) which were treated with a mixture of KNO₃ and Al₂O₃ in accordance with the inventive method show uniform and high strengths, as compared with the original glass plate not treated. The glass plate (1-1) treated only with KNO₃ was unsatisfactory in terms of uniformity.

### EXAMPLE 2

A powdered mixture of potassium nitrate (KNO₃), aluminum oxide (Al₂O₃) and aluminum trichloride (AlCl₃) having the composition shown in Table 2 was placed on the surface of the same glass plate as in Example 1, to form an 1 to 2 mm-thick solid layer thereon.

The glass plate with the solid layer was placed in a furnace, heated to 460° C. over 1 hr, and then, maintained at that temperature for 1 hr. The heat-treated glass plate was cooled to 20° C. over 2 hrs and washed with distilled water to remove the residual powder layer.

The average microhardness (MPa) of each of the glass plates ((2-1) to (2-4)) thus obtained was determined at five points using a 100 g load with a Vicker's hardness gage. The results are shown in Table 2. An SEM photograph of the surface of the glass plate (2-4) treated with a mixture of 50 mol % of potassium nitrate, 40 mol % of aluminum oxide and 10 mol % of aluminum trichloride is shown in FIG. 2.

TABLE 2

| | Salt-containing | | | Average | |
|---|---|---|---|---|---|
| | mixture (mol %) | | | microhardness | Standard |
| Sample | KNO₃ | Al₂O₃ | AlCl₃ | (MPa) | variation |
| Control | — | — | — | 583.5 | 13.8 |
| (2-1) | 50 | 10 | 40 | 623.5 | 7.1 |
| (2-2) | 50 | 20 | 30 | 618.0 | 8.4 |
| (2-3) | 50 | 30 | 20 | 621.2 | 9.4 |
| (2-4) | 50 | 40 | 10 | 621.1 | 5.9 |

As shown in Table 2, the glass plates ((2-1) to (2-4)) which were treated with a mixture of KNO₃, Al₂O₃ and AlCl₃ in accordance with the inventive method show uniform and high strengths, as compared with the original glass plate not treated. In addition, the photograph of FIG. 2 shows that the surface of the glass plate (2-4) is significantly rough, which confirms that both the strength and roughness of the glass plate were enhanced.

### EXAMPLE 3

The procedure of Example 1 was repeated except that a mixture of 35 mol % of potassium nitrate and 65 mol % of aluminum oxide was used, and that the heat-treatment (ion-exchange) temperature was changed as shown in Table 3, to prepare various glass plates.

The average microhardness (MPa) of each of the glass plates ((3-1) to (3-5)) thus obtained was determined at five points using a 100 g load with a Vicker's hardness gage. The results are shown in Table 3.

TABLE 3

| | Ion-exchange | Average | Standard |
|---|---|---|---|
| Sample | temperature (° C.) | microhardness (MPa) | variation |
| Control | — | 583.5 | 13.8 |
| (3-1) | 360 | 595.1 | 10.6 |
| (3-2) | 380 | 599.4 | 8.7 |
| (3-3) | 400 | 610.2 | 6.6 |
| (3-4) | 450 | 618.4 | 5.3 |
| (3-5) | 500 | 620.6 | 6.2 |

As shown in Table 3, the glass plates ((3-1) and (3-2)) heat-treated at temperatures lower than 400° C. exhibited unsatisfactory strengths, while the glass plates ((3-3) to (3-5)) heat-treated at 400˜500° C. in accordance with the inventive method show uniform and satisfactory strengths.

As described above, in accordance with the method of the present invention, a high strength flat glass plate suitable for use in preparing a display can be easily prepared.

While the invention has been described with respect to the above specific embodiments, it should be recognized that various modifications and changes may be made to the invention by those skilled in the art which also fall within the scope of the invention as defined by the appended claims.

What is claimed is:

1. A method for strengthening a flat glass plate which comprises the steps of: forming a solid layer comprising a potassium salt and an inorganic oxide on the glass plate; heat-treating the glass plate having the solid layer at a temperature ranging from 400° C. to the strain point of the glass to allow ion exchange of alkali metal ions between the solid layer and the glass plate surface to take place; and cooling and washing the heat-treated glass plate.

2. The method of claim 1, wherein the solid layer comprises 30 to 90 mol % of the potassium salt and 10 to 70 mol % of the inorganic oxide.

3. The method of claim 1, wherein the potassium salt is potassium nitrate or potassium chloride.

4. The method of claim 1, wherein the inorganic oxide is selected from the group consisting of aluminum oxide, zinc oxide and zircon oxide.

5. The method of claim 1, wherein the solid layer further comprises aluminum trichloride.

6. The method of claim 5, wherein the solid layer comprises 30 to 80 mol % of the potassium salt, 10 to 60 mol % of the inorganic oxide and 10 to 40 mol % of aluminum trichloride.

7. The method of claim 5, wherein the potassium salt is potassium nitrate and the inorganic oxide is aluminum oxide.

8. A flat glass display plate obtained by the method of claim 1.
